(19) United States
(12) Patent Application Publication
(10) Pub. No.: US 2009/0292525 A1
(43) Pub. Date: Nov. 26, 2009

(54) APPARATUS, METHOD AND STORAGE MEDIUM STORING PROGRAM FOR DETERMINING NATURALNESS OF ARRAY OF WORDS

(75) Inventor: Junichi Goishi, Osaka (JP)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: ROZETTA CORPORATION, Tokyo (JP)

(21) Appl. No.: 12/091,687

(22) PCT Filed: Oct. 25, 2006
(86) PCT No.: PCT/JP2006/321804

§ 371 Date: Apr. 25, 2008

(30) Foreign Application Priority Data
Oct. 28, 2005 (JP) 2005-315261

(51) Int. Cl. G06F 17/27; G06F 17/30

(52) U.S. Cl. 704/9; 707/6; 707/E17.069

(57) ABSTRACT

An apparatus is provided which determines the naturalness of an array of words as a sentence. When an entire source text to be translated is not registered in a lexicon, the source text is divided into plural words. A parallel translation for each word in the source text is obtained to generate parallel translation patterns, and a web search is made for a text which includes each of the parallel translation patterns (step 36 to 44).

### BACKGROUND OF THE INVENTION

1. Field of the Invention

The present invention relates to an apparatus, a method, and a storage medium storing a program for determining the naturalness of an array of words, in particular to an apparatus for determining the naturalness of an array of words which is realized in a computer connected to the Internet, a method for determining the naturalness of an array of words which can be applied to the apparatus for determining the naturalness of an array of words, and a storage medium storing a program for determining the naturalness of an array of words which is implemented in a computer functioning as the apparatus for determining the naturalness of an array of words.

2. Description of the Related Art

A realization of a translation system in which a sentence (source text) described in a natural language (source language) is translated into another sentence (parallel/corresponding translated text) described in another natural language (target language), so-called automatic translation, has been expected for quite a long time, and various improved technologies for the automatic translation have been suggested.

For example, EBMT (Example Based Machine Translation) and TDMT (Transfer Driven Machine Translation) are well known representative approaches for automatic translation. In EBMT, a number of pairs of source language examples and target language examples are registered in a corpus so that an example which is the most similar to a source text is retrieved in the corpus to be used for translation. In TDMT, a translation is performed by learning transfer knowledge from a corpus in a constituent boundary pattern which is a basic structural unit of syntax and using the transfer knowledge for the translation. Japanese Patent Application Laid-Open No. 2003-263434 discloses another technology that: input data is translated by two translation systems TDMT and EBMT; a sentence structure score showing similarity between the input data and examples in translating the input data by TDMT, and a DP distance showing similarity between the input data and examples in translating the input data by EBMT, are computed; and evaluation data showing whether TDMT or EBMT are suitable for the translation of the input data, and the sentence structure score and the computed DP distance, are used to generate a selector for selecting the translation system suitable for the translation of the input data.

However, a parallel translated text which is generated by using the existing automatic translation technology is often an unnatural sentence in a target language even if the parallel translated text does not have any grammatical errors or parallel translation errors in word units, and accuracy in translation for practical use actually has not been achieved yet by the conventional automatic translation technologies including the disclosure of the above-described patent. The reason for this is assumed to be because no mechanism is equipped, to the existing automatic translation apparatuses, to determine and evaluate whether a parallel translated text which is generated by automatic translation is natural as a sentence in a target language or not. However, it is difficult to quantitatively measure the naturalness of a sentence because the measurement relies on sensory indexes, and it is also difficult to define a criterion to determine the naturalness of an array of words, which is generated as a sentence in a target language. Therefore, a technology to determine the naturalness of an array of words as a sentence which is obtained as a parallel translated text by automatic translation, or an array of words which is manually composed as a sentence by a person, is not yet established.

### SUMMARY OF THE INVENTION

The present invention was made in consideration of the above facts, and one object of the present invention is to provide an apparatus for determining the naturalness of an array of words which can fairly determine the naturalness of an array of words as a sentence, a method for determining the naturalness of an array of words, and a storage medium storing a program for determining the naturalness of an array of words.

In order to achieve the above object, a first aspect of the present invention is an apparatus for determining the naturalness of an array of words which is realized in a computer connected to the Internet, the apparatus including: a searching section, for searching for an array of words specified as a search object in texts accessible via Internet; and a determining section for causing the searching section to perform the search by specifying, as a search object, an array of words of a determination object in which a plurality of words are arrayed, and determining the naturalness of the array of words as a sentence, based on the presence or absence of a text extracted by the search and the number of the extracted texts.

There are a huge amount of texts accessible via Internet, and the texts include various contents described in different languages. Although some texts may include unnatural description as a sentence, since the texts are made on an assumption of accesses and references by people, most texts can be considered to be written in natural sentences. Further, although a criterion itself on the naturalness of sentences in individual language will shift in a long period of time, the texts accessible via Internet are updated, deleted, or added on daily basis, and the updated or added texts can be considered to reflect a criterion shift on the naturalness of sentences at that time. The inventor of this invention focused attention on the above described feature that the entire texts accessible via Internet has, which led to a conclusion that, by using the entire texts accessible via Internet as a criterion, the naturalness of an array or words as a sentence can be determined, resulting in consumption of the present invention.

As described above, an apparatus for determining the naturalness of an array of words according to the first aspect of the present invention is realized in a computer connected to the Internet, and includes a searching section for searching for an array of words which is specified as a search object in texts accessible via the Internet. The determining section according to the first aspect of the present invention operates the searching section to perform the search by specifying, as a search object, an array of words of a determination object in which a plurality of words are arrayed, and determines the naturalness of the specified array of words of the determination object as a sentence based on the presence or absence of a text extracted by each search and the number of the extracted texts by the searching section.

The array of words of the determination object may be a sentence which is manually composed, or may be a sentence, as described below, that an array of parallel (corresponding) translated words which is automatically generated by combining a parallel translated word in a target language that corresponds to each word of a source text in a source language, or an array of words which corresponds to a part of the source sentence. The array of words specified as the search object for the searching section may be the entire array of words of the determination object, or divided parts of the array of words of the determination object for sequential searches for a text including each of the parts. In determining the naturalness of the array of words by the determining section, specifically, when a relevant text is extracted in the search by the searching section, the array of words is determined to have “higher naturalness” than arrays of words for which no text is extracted, and when a relevant text is extracted in the search by the searching section, the array of words for which more texts are extracted is determined to have “higher naturalness” than arrays of words for which less texts are extracted.

In this way, according to the first aspect of the present invention, after a text which includes the array of words of the determination object (all or a part thereof) is searched among the texts accessible via the Internet, the naturalness of the specified array of words of the determination object as a sentence is determined based on the presence or absence of a text extracted by each of the search and the number of the extracted texts. This allows a fair determination on the naturalness of the array of words as a sentence to be achieved. As the criterion itself on the naturalness of sentences in a language shifts, the criterion on the naturalness of sentences in the language which is represented in the entire text described in the language among the texts accessible via the Internet also shifts. Therefore, the apparatus according to the first aspect of the present invention eliminates a maintenance operation for detecting any criterion shift of the naturalness of sentences in a language, and updating, deleting, or adding texts in a storing section depending on the detected shifts, in comparison to an apparatus which stores texts which are referred by a searching section at the time of searching, in a storing section in advance.

The determining section according to the first aspect of the present invention may be, for example, preferably configured so that the determining section specifies the entire array of words of the determination object as a search object and causes the searching section to perform a search for the array, and when no relevant text is extracted by the search, the determining section repeatedly performs processing of extracting, from the array of words of the determination object, a subarray of words, as a search object, which has a smaller length than the entire array of words of the determination object, and causing the searching section to perform a search by specifying the subarray of words as a search object, with the length of the subarray of words to be extracted as a search object being reduced gradually, and determines the naturalness of the array of words as a sentence based on the presence or absence of a text extracted by the search, the number of texts extracted by the search, and the length of the subarray of words as the search object for which the text is extracted.

Even if there is no text which includes the entire array of words of the determination object in the texts accessible via the Internet, there can be found a text which includes a part of the array of words (a subarray of words) of the determination object. In a search of the subarray of words, the number of words in the subarray of words as the search object for which a relevant text is extracted relates to the determination of the naturalness of the corresponding array of words of the determination object as a sentence: the more words the subarray of words as the search object and for which a relevant text is extracted has, the sentence can be considered to have higher naturalness. Therefore, in the present invention, when there is no relevant text extracted by the search by specifying the entire array of words of the determination object as the search object, a search using an subarray of words as a search object is repeated with the length of the subarray of words which is extracted from the array of words of the determination object as the search object being reduced gradually. This allows the determining section to determine the naturalness of the array of words of the determination object as a sentence based on the presence or absence, and the number of texts extracted by the search by the searching section and the number of words in the subarray of words as the search object for which the text is extracted, which leads to further fair determination of the naturalness of the array of words as a sentence.

In the first aspect of the present invention, in order to obtain a parallel translated text which has higher naturalness as a sentence from a source text in a source language, for example, an apparatus according to the present invention may be preferably configured to further include: a generating section for obtaining a parallel (corresponding) translated word in a target language for each word of a source text in a source language and generating, as the array of words of the determination object, a plurality of arrays of parallel translated words in the target language, which correspond to combinations of the parallel translated words obtained for each word of the source text, wherein the determining section specifies, as a search object, each of the plurality of arrays of parallel translated words generated by the generating section, and causes the searching section to perform a search for each of the arrays, and the determining section selects an array of parallel translated words which has higher naturalness as a sentence in the target language from among the plurality of arrays of parallel translated words based on the presence or absence of a text extracted by each search and the number of the extracted texts.

In the present invention, a plurality of arrays of parallel translated words in a target language which correspond to a combination of the parallel translated words obtained for each word in a source text are generated by a generating section. The plural arrays of parallel translated words will be candidates for a parallel translated text in the target language which corresponds to the source text in the source language, and the determining section specifies each of the plural arrays of parallel translated words generated by the generating section as a search object, and operates the searching section to perform a search for each array, thereby selects an array of parallel translated words which has higher naturalness as a sentence in the target language from among the plural arrays of parallel translated words based on the presence or absence of a text extracted by each search, and the number of the extracted texts for each array. For the array of parallel translated words which has higher naturalness as a sentence in the target language, for example, the determining section may select only one array of parallel translated words for which the largest number of texts are extracted by the search by the searching section, or may select arrays of parallel translated words for which texts are extracted by the search by the searching section and the number of texts has a predetermined percentage or more with respect to the largest number of extracted texts for the above array.

In this way, because the searches are made in texts accessible via the Internet for each of the plural arrays of parallel translated words (a plurality of candidates for a parallel translated text) which are generated from the source text, indexes (the presence or absence of a text extracted by each search, and the number of the extracted texts) to fairly determine the naturalness of each array of parallel translated words as a sentence can be obtained. Based on the indexes, an array of parallel translated words which has higher naturalness as a sentence in the target language can be selected from among the plural arrays of parallel translated words. Thus, among the plural arrays of parallel translated words (the plural candidates for the parallel translated text), an array of parallel translated words which has higher naturalness as a sentence in the target language, that is a more appropriate parallel translated text as the parallel translated text for the source text (or an array of parallel translated words which corresponds to the parallel translated text) can be selected.

In this configuration, the present invention may be, for example, preferably configured so that the determining section specifies, as a search object, the entirety of the array in the plurality of arrays of parallel translated words and causes the searching section to perform a search for each of the arrays, and when no relevant text is extracted by the search, the determining section repeatedly performs processing of causing the generating section to generate a plurality of subarrays of parallel translated words each of which has smaller length than the entirety of the array in the plurality of arrays of parallel translated words, the plurality of subarrays being combinations of the parallel translated words corresponding to a predetermined number of words in series in the source text in the source language, and the determining section specifying each of the generated subarrays of the plurality of parallel translated words as a search object and causing the searching section to perform a search for each of the subarrays, with the number of the words in the source text to be used for the generation of the subarrays of parallel translated words being reduced gradually, and the determining section selecting an array of parallel translated words which has higher naturalness as a sentence in a target language from among the arrays of the plurality of parallel translated words based on the presence or absence of a text extracted by the search, the number of the extracted texts, and the number of words in the subarray of parallel translated words as the search object for which the text is extracted.

This allows a more appropriate parallel translated text (or an array of parallel translated words which corresponds to the parallel translated text) to be selected as a parallel translated text for the source text even if there is no text which includes the entire array of parallel translated words in the texts accessible via the Internet.

Furthermore in the above configuration, more specifically, the present invention may be preferably configured to further including a storing section, wherein every time a relevant text is extracted by the search, the determining section stores the subarray of parallel translated words used for the search in the storing section, and excludes the predetermined number of words in the source text which correspond to the stored subarray of parallel translated words from words to be used for a subsequent generation of a subarray of parallel translated words, and when no more words in series exists in the source text which can be used for a subsequent generation of a subarray of parallel translated words, for each of the stored combinations of the subarrays of parallel translated words, the determining section causes the searching section to perform a search for a text which includes all of the parallel translated words in the combination, and the determining section selects a combination of the subarrays of parallel translated words which has higher naturalness as a sentence in the target language from among the stored combinations of subarrays of parallel translated words which, based on the presence or absence of a text which includes all of the parallel translated words in the combination and the number of the texts which includes all of the parallel translated words and are extracted by the search.

As described above, every time a relevant text is extracted by the search by the searching section, a predetermined number of words in the source text which correspond to the subarray of parallel translated words are excluded from words to be used for the subsequent generation of subarrays of parallel translated words. This allows the source text to be divided into arrays of words according to a dividing pattern which is considered to provide a more probable parallel translated text based on the search result (the presence or absence of the corresponding subarray of parallel translated words in the texts accessible via the Internet) by the searching section. In the storing section, the subarray of parallel translated words, which corresponds to each array of words in the source text after the division according to the dividing pattern, is stored.

In this configuration, when there are no more words in series that can be used for a subsequent generation of subarrays of parallel translated words in the source text, for each of the combinations of the subarrays of parallel translated words which are stored in the storing section, a search for a text which includes all of the parallel translated words in each of the combinations of the subarrays is made. This allows a determination on the possibility (which is called co-occurrence probability) of all of the parallel translated words in the combination being included in a text to be made, for each combination of the subarrays of parallel translated words based on the search result. A combination of subarrays of parallel translated words which has higher naturalness as a sentence in the target language among the combinations of subarrays of parallel translated words which are stored in the storing section is selected on the basis of the presence or absence of a text which includes all of the parallel translated words in the combination and the number of the texts which include all of the parallel translated words and are extracted by the search. Therefore, a more appropriate parallel translated text (or a combination of subarrays of parallel translated words which corresponds to the parallel translated text) as a parallel translated text for the source text can be selected based on the co-occurrence probability for each combination of the subarrays of the parallel translated words.

A second aspect of the present invention is a method for determining the naturalness of an array of words which is realized in a computer connected to Internet, the method including: searching for an array of words of a determination object, in which a plurality of words is arrayed, in texts accessible via the Internet; and determining the naturalness of the array of words of the determination object as a sentence based on the presence or absence of a text extracted by the search and the number of the extracted texts.

Thus, the second aspect of the present invention allows a fair determination of the naturalness of an array of words as a sentence.

A third aspect of the present invention is a storage medium storing a program for determining the naturalness of an array of words, which allows a computer connected to the Internet to function as an apparatus for determining the naturalness of an array of words, the program causes the computer to perform processings including: searching for an array of words, which is specified as a search object, in texts accessible via Internet, the search is performed by specifying as the search object an array of words of a determination object in which a plurality of words is arrayed; and determining the naturalness of the specified array of words of the determination object as a sentence based on the presence or absence of a text extracted by the search, and the number of the extracted texts.

Since the storage medium storing the program for determining the naturalness of an array of words according to the third aspect of the present invention allows a computer connected to the Internet to function as the searching section and the determining section described above, and when the computer executes the program for determining the naturalness of an array of words, the computer functions as the apparatus for determining the naturalness of an array of words according to the first aspect of the present invention, which allows a fair determination of the naturalness of an array of words as a sentence.

As explained above, the present invention provides an apparatus which searches for an array of words of a determination object in which a plurality of words are arrayed in texts accessible via the Internet, and determines the naturalness of the array of words of the determination object as a sentence based on the presence or absence of a text extracted by the search and the number of the extracted texts. Thereby the apparatus has an advantageous effect to achieve a fair determination on the naturalness of an array of words as a sentence.

### BRIEF DESCRIPTION OF THE DRAWINGS

FIG. 1 is a block diagram showing a schematic structure of an embodiment of a computer system according to the present invention;

FIG. 2 is a flowchart showing processings of a parallel translation determination; and

FIGS. 3A and 3B are conceptual diagrams showing other embodiments of a computer according to the present invention.

### DESCRIPTION OF THE PREFERRED EMBODIMENT

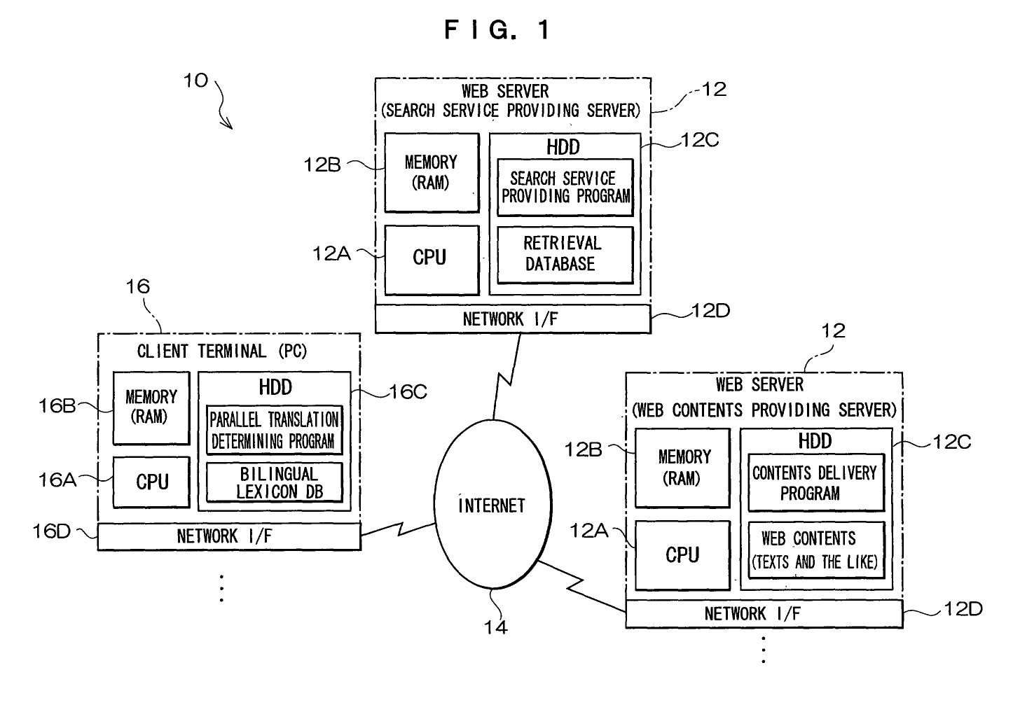

Now, an example of an embodiment of the present invention will be explained in detail below with reference to the accompanying drawings. FIG. 1 shows a computer system 10 according to this embodiment. The computer system 10 includes a number of client terminals 16, each of which is connected to the Internet 14 to which a number of web servers 12 are connected.

The individual client terminal 16 which is connected to the Internet 14 includes a personal computer (PC) for example, has a CPU 16A, a memory 16B including RAM or the like, a hard disc drive (HDD) 16C or a storage device/medium in which programs including OS (Operating System) and a browser are installed, and a network interface (I/F) section 16D, and is connected to the Internet 14 via the network section 16D. The client terminal 16 is also connected with inputting means including displaying means such as a display, a mouse, and a key board (not shown).

The individual client terminal 16 which is connected to the Internet 14 also includes a client terminal 16 which functions as an apparatus for determining the naturalness of an array of words according to the present invention. Such client terminal 16 has a HDD 16C in which a parallel translation determining program is installed in advance for implementation of processing for parallel translation determination which will be described below, and in which a bilingual (or multilingual/parallel translation) lexicon database (DB) is also stored. This parallel translation determining program corresponds to the program for determining the naturalness of an array of words. In the bilingual lexicon DB, a number of text data of words (words, clauses which consist of plural words, collocations, and the like) described in a source language are registered in correspondence to parallel translation text data described in a target language.

The individual web server 12 has a CPU 12A, a memory 12B including RAM or the like, a HDD 12C in which a program such as OS is installed, and a network interface (I/F) section 12D, and is connected to Internet 14 via the network (I/F) section 12D. Among the various web servers 12, a web server (web contents providing server) 12, which provides any web contents such as texts, images, music, and the like, has web contents such as texts or the like stored in the HDD 12C. A content delivery program is also installed therein for content delivery processing in which, upon a request for delivery of any web content(s) by a computer (any client terminal 16 or any web server 12) via Internet 14, the requested web content is delivered to the requesting computer.

Among the various web servers 12, there is a web server 12 (a server providing searching service), which provides a web search service to present a search result of a search for texts having specified key words from among the huge texts (web documents) accessible on the Internet. Such web server 12 which functions as a web search service providing server has an HDD 12C in which a retrieval database (DB) is stored and also a search service providing program is installed in advance. When the CPU 12A executes the search service providing program, the web server 12, which functions as the web search service providing server, performs web search service providing processing including: sequentially examining a number of web documents by following links of the web documents; upon a detection of an uncollected or updated document, saving the contents of the detected web document in a retrieval DB or updating the saved information corresponding to the detected web document in the retrieval DB; and upon a request for a retrieval by a specified keyword, retrieves the retrieval DB by using the specified keyword and outputs the result.

Next, operations of the embodiment will be explained. In this embodiment, when a user wishes to know a parallel translated text described in a target language which corresponds to a source text described in a source language, the user performs an operation on a client terminal 16 to specify the source text as a translation object and the target language to be translated. The source text may be any text which can be read into the client terminal 16 as text data, including a text which is input by a user using a key board, a text which is created by using a word processor software and already stored in the HDD 16C, a text in a web document which the user is viewing among the texts accessible via the Internet 14 through a browser, a text obtained by a reading processing with a use of OCR (Optical Character Recognition: text recognition by an optical approach), and the like. The source text is not necessarily limited to a sentence, and may be a clause, a collocation, and the like which includes a plurality of words.

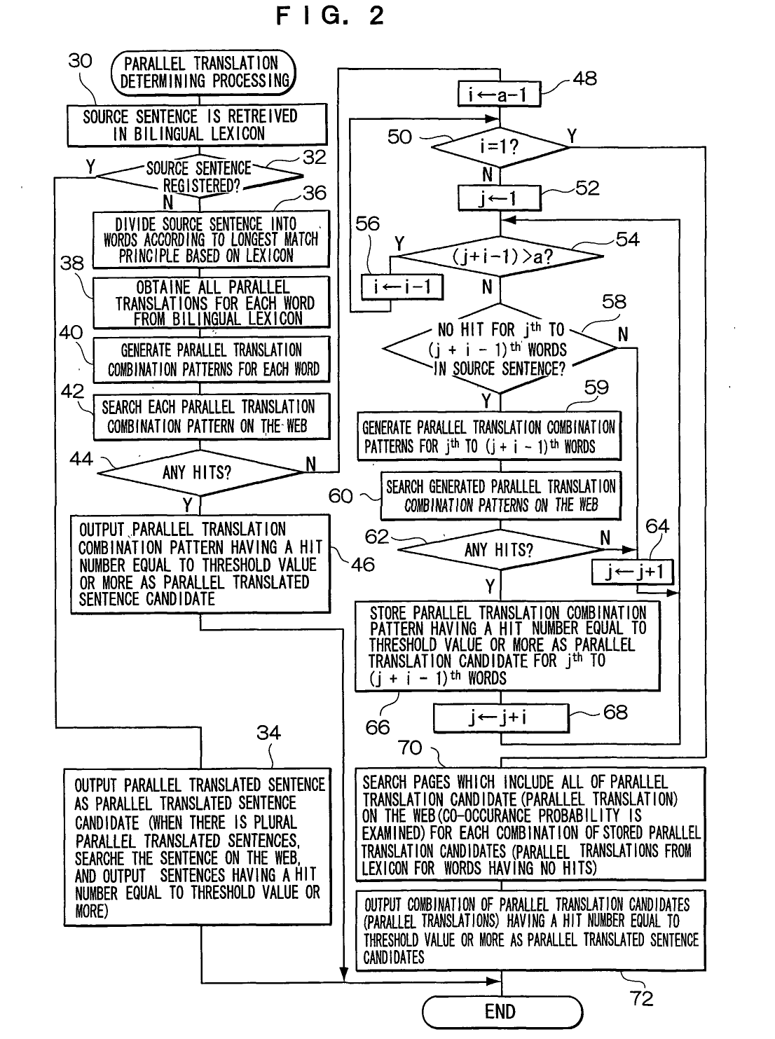

When a source text to be translated is specified as described above, the CPU 16A of the client terminal 16 executes the parallel translation determining program, and thereby the processings for parallel translation determination shown in FIG. 2 are operated. The method for determining naturalness of an array of words is applied to these processings for parallel translation determination, and the operation of the processings makes the client terminal 16 to function as an apparatus for determining naturalness of an array of words.

In the processing for parallel translation determination according to the embodiment, at Step 30, the whole source text which has been specified as a translation object is retrieved in the bilingual lexicon DB whether it is registered (stored) therein or not. Next at Step 32, it is determined if the whole text was found in the bilingual lexicon DB by the retrieval at step 30. When a positive determination is made at Step 32, then at Step 34, a parallel translation (text) registered in the bilingual lexicon DB is read out in association with the whole source text found in the retrieval at Step 30, and the read out parallel translation (text) is output as a parallel translated text candidate which corresponds to the source text (for example, the read out parallel translation (text) is displayed on a display or the like of the client terminal 16). Then, the processing for parallel translation determination is completed. If a plurality of parallel translations (texts) are registered in the bilingual lexicon DB in association with the whole source text, as will be explained below for a web search, texts which include the individual parallel translation (text) are searched by using the search service which is provided by the search service providing server, and a parallel translation (text) for which relevant texts are extracted by the searching and the numbers of the extracted texts as a proportion to numbers of other extracted texts are equal to or larger than a threshold value (which will be explained below) is output as a parallel translated text candidate.

When the whole source text is not found from the bilingual lexicon DB as a result of the retrieval at Step 30, a negative determination is made at Step 32, and the processing moves to Step 36. At Step 36 a longest match principle is applied to the source text to divide the source text into a plurality of words (or arrays of words) with reference to the bilingual lexicon DB. In this dividing of the source text, an approach by a retrieval from the bilingual lexicon DB is applied, instead of the web searches performed at Step 48 to Step 68 which will be explained below, and achieved by: extracting a subset of an array of words which has a predetermined length (a predetermined number of constituent words) of the source text; retrieving the extracted subset of the array of words from the bilingual lexicon DB; storing the subset of the array of words as a portion to be separated when the subset of the array of words is found to have been registered in the bilingual lexicon DB; removing each word in the subset of the array of words from the a subset of the array of words to be extracted in subsequent steps, and repeating these operations with the number of words in a subset of an array being reduced (i.e., by decrementing the number of constituent words one by one) until the source text has no more adjacent words which can be extracted as a unit (as a subset of an array of words). Hereinafter, the words or the array of words which are divided from a source text by the longest match principle at Step 36 will be simply referred to as “words”, and the total number of the words (the number of divided words) will be referred to as “a”.

At Step 38, all parallel translations corresponding to the individual words which are divided from the source text at Step 36 are obtained from the bilingual lexicon DB, and the obtained parallel translations for the individual words are stored in the HDD 16C. At the next Step 40, combination patterns of the parallel translations for the individual words obtained at Step 38 are generated. That is, for example, when the number of the divided words is a, and each number of parallel translations of the individual words are n₁, n₂, . . . , nₐ respectively, a number n₁×n₂× . . . ×nₐ of combination patterns of the parallel translations will be generated. Step 40 corresponds to the generating section of the apparatus according to the present invention.

At the next Step 42, a web search is sequentially performed to search for a text, which includes the individual parallel translation combination pattern generated at Step 40, from all the texts accessible via the Internet 14 by using the search service which is provided by the web search service providing server. Specifically, Step 40 includes: accessing a web site which provides a retrieval service operated by a web search service providing server; specifying a certain parallel translation combination pattern as a keyword for searching, and issuing a command to execute a search; and storing, in the HDD 16C, the search result (a number of hits on the texts which include the specified keyword) which is sent from the web search service providing server. The searching conditions can be specified so that only texts in which the individual parallel translated words of a certain parallel translation combination pattern appear in series in the same order as that in the certain parallel translation combination pattern are searched. These operations are sequentially repeated for each of the generated parallel translation combination patterns.

Step 42 corresponds to the searching section according to the present invention, and also corresponds to the step that the determining section specifies the entire array of words of the determination object as a search object and operates the searching section to perform a search for the array, and the step that the determining section specifies, as a search object, the entire of the plurality of arrays of parallel translated words and operates the searching section to perform a search for each of the array.

At Step 44, the search result stored in the HDD 16C is referred, and determined if a parallel translation combination pattern for which a text was searched out by the web search at Step 42 (the number of hit is one or more) is found or not. When the determination is positive, at Step 46, the number of parallel translation combination patterns for which a text was searched out by the web search is recognized. When the recognized number is one, the only one parallel translation combination patterns for which a text is searched out by the web search is output as a parallel translated text candidate which corresponds to the source text, by displaying the pattern on a display or the like of the client terminal 16 for example, and the processing for parallel translation determination is completed. When there are plural parallel translation combination patterns for which text is searched by the web search, the parallel translation combination pattern having the largest number of hit texts among the parallel translation combination patterns is determined, and on the basis of the parallel translation combination pattern with the largest number of hit texts (taken as 100%), proportions of the numbers of hit texts for other parallel translation combination patterns with respect to the largest number of hit texts are computed. The parallel translation combination patterns which have proportions of the number of hits equal to or larger that a threshold value are output as parallel translated text candidates which correspond to the source text by displaying the pattern on a display of the client terminal 16 for example, and the processing for parallel translation determination is completed.

In this way, among the plural parallel translation combination patterns which correspond to the entire source text generated at Step 40, the parallel translation combination patterns which have the highest naturalness or higher naturalness as a sentence in the target language are output as parallel translated text candidates which correspond to the source text. Step 44 and Step 46 corresponds to the determining section according to the present invention.

Now, the above processing at Step 36 to Step 46 will be explained below by way of an actual example. For example, when “Eiyo-Shiccho” in Japanese is specified as a source text of a translation object, English is specified as a target language, and the entire source text (“Eiyo-Shiccho”) of the translation object has not been registered in a bilingual lexicon DB, a negative determination is made at Step 32, and at Step 36 the source text is divided into individual words of “Eiyo” and “Shiccho” (the number of dividing words a=2). Then at Step 38, parallel translations are obtained from the bilingual lexicon DB for each word. If the parallel translations for “Eiyo” include five words of “dietary”, “alimentary”, “nutritional”, “nutrition”, and “trophic”, and the parallel translations for “Shiccho” include four words of “deficiency”, “disorder”, “disturbance”, and “disease”, at Step 40 n₁×n₂=5×4=20 of parallel translation combination patterns are generated (see Table 1 below).

TABLE 1
<An Example of Parallel Translation Combination Pattern for “Eiyo-Shiccho”>

| | Combination Pattern | | Combination Pattern | | Combination Pattern |
|---|---|---|---|---|---|
| 1 | dietary deficiency | 2 | dietary disorder | 3 | dietary disturbance |
| 4 | dietary disease | 5 | alimentary deficiency | 6 | alimentary disorder |
| 7 | alimentary disturbance | 8 | alimentary disease | 9 | nutritional deficiency |
| 10 | nutritional disorder | 11 | nutritional disturbance | 12 | nutritional disease |
| 13 | nutrition deficiency | 14 | nutrition disorder | 15 | nutrition disturbance |
| 16 | nutrition disease | 17 | trophic deficiency | 18 | trophic disorder |
| 19 | trophic disturbance | 20 | trophic disease | | |

When a search result such an shown in Table 2 below for example is obtained by the web search at Step 42 (in Table 2, the parallel translation combination patterns are ranked in descending order of the number of hits), since the parallel translation combination pattern “nutritional deficiency” gets the largest number, 79600, of hits, the pattern “nutrition disease” occupies a proportion of 86% of the number of hits, and the pattern “dietary deficiency” occupies a proportion of 38% of the numbers of hits. If the threshold value for the proportions of the number of hits to allow the parallel translation combination patterns to be output as parallel translated text candidates is 70% for example, “nutritional deficiency” and “nutrition disease” will be output as parallel translated text candidates. If the threshold value for the proportions of the number of hits to allow the parallel translation combination patterns to be output as parallel translated text candidates is 100%, only one parallel translation combination pattern is output as a parallel translated text candidate in every case (“nutritional deficiency” in this case).

TABLE 2
<An Example of Web Search Results on Parallel Translation Combination Patterns>

| | Combination Pattern | Number of Hits | | Combination Pattern | Number of Hits |
|---|---|---|---|---|---|
| 1 | nutritional deficiency | 79600 | 2 | nutrition disease | 68200 |
| 3 | dietary deficiency | 30500 | 4 | nutritional disorder | 13300 |
| 5 | nutritional disease | 10600 | 6 | nutrition deficiency | 4710 |
| 7 | nutrition disorder | 1360 | 8 | nutritional disturbance | 647 |
| 9 | dietary disease | 521 | 10 | dietary disorder | 394 |
| 11 | alimentary disease | 278 | 12 | alimentary disorder | 173 |
| 13 | trophic disorder | 72 | 14 | trophic disturbance | 67 |
| 15 | dietary disturbance | 56 | 16 | alimentary deficiency | 55 |
| 17 | nutrition disturbance | 20 | 18 | trophic disease | 7 |
| 19 | trophic deficiency | 5 | 20 | alimentary disturbance | 0 |

The parallel translation combination patterns generated at Step 40 are not limited to patterns of an array of parallel translated words in sequence which are divided from the source text (for example, a pattern of an array of “[A] [B]” where [A] is a parallel translation for word A and [B] is a parallel translation for word B in a source text=(A, B) and A and B are individual words). Other patterns may be generated such as [B] of [A] when the target language is English for example (the same as in the case of generation of parallel translation combination patterns at Step 60 which will be explained below). Table 3 below shows parallel translation combination patterns and a web search result for the example described above with Tables 1 and 2 when the pattern of “[B] of [A]” is also generated as a parallel translation combination pattern in addition to the pattern “[A][B]”. As shown in Table 3, since the number of type of patterns is p=2 in this example, n₁×n₂×p=5×4×2=40 of parallel translation combination patterns are generated, and for each of which a web search is performed.

TABLE 3
#1 <An Example of Parallel Translation Combination Patterns
and Web Search Results for “Eiyo-Shiccho”>

| | Combination Pattern | Number of Hits | | Combination Pattern | Number of Hits |
|---|---|---|---|---|---|
| 1 | nutritional deficiency | 79600 | 2 | nutrition disease | 68200 |
| 3 | dietary deficiency | 30500 | 4 | nutritional disorder | 13300 |
| 5 | nutritional disease | 10600 | 6 | nutrition deficiency | 4710 |
| 7 | nutrition disorder | 1360 | 8 | nutritional disturbance | 647 |
| 9 | deficiency of dietary | 584 | 10 | dietary disease | 521 |
| 11 | dietary disorder | 394 | 12 | deficiency of nutritional | 292 |
| 13 | alimentary disease | 278 | 14 | alimentary disorder | 173 |
| 15 | deficiency of nutrition | 131 | 16 | disorder of nutrition | 125 |
| 17 | disease of nutrition | 112 | 18 | disturbance of nutrition | 86 |
| 19 | disease of dietary | 73 | 20 | trophic disorder | 72 |
| 21 | trophic disturbance | 67 | 22 | disease of nutritional | 62 |
| 23 | dietary disturbance | 56 | 24 | alimentary deficiency | 55 |
| 25 | nutrition disturbance | 20 | 26 | disturbance of nutritional | 20 |
| 27 | deficiency of trophic | 17 | 28 | disease of alimentary | 11 |
| 29 | deficiency of alimentary | 10 | 30 | disturbance of trophic | 8 |
| 31 | disturbance of alimentary | 8 | 32 | trophic disease | 7 |
| 33 | trophic deficiency | 5 | 34 | disease of trophic | 0 |
| 35 | disturbance of dietary | 0 | 36 | disorder of trophic | 0 |
| 37 | disorder of nutritional | 0 | 38 | disorder of alimentary | 0 |
| 39 | disorder of dietary | 0 | 40 | alimentary disturbance | 0 |

In the example shown in Table 3, the parallel translation combination patterns which have higher proportions of the number of hits than other patterns are the same as in Table 2. Therefore, if the threshold value for the proportions of the number of hits to allow parallel translation combination patterns to be output as parallel translated text candidates is 70%, “nutritional deficiency” and “nutrition disease” will be output as parallel translated text candidates for the source text “Eiyo-Shiccho” as in the case of Table 2. However, other parallel translation combination patterns which correspond to the pattern “[B] of [A]” may be output for another source text, thereby enhances the probability for the output of more appropriate parallel translated text candidates.

In the above description with reference to Table 1 to Table 3, an example has been used in which a source text having only few words is specified to be translated, for simplicity of explanation. However, actually a sentence is often specified as a source text to be translated, and this often resulting in a case that no text is found which includes any one of the parallel translation combination patterns generated at Step 40. In this case, after a negative determination is made at Step 44, at Step 48 to Step 72, processing to select and output parallel translated text candidates are executed by specifying parallel translation combination patterns as a search object, which correspond to a part of an array of words of the source text, and repeatedly performing web searches for each of the parallel translation combination patterns is performed.

The case in which a negative determination is made at Step 44 corresponds to the condition of no relevant text is extracted by the search in which the determining section specifies, as a search object, the entire array of words of the determination object, and the condition of no relevant text is extracted by the search for the array in which the determining section specifies, as a search object, the entire array of words of the determination object. The flow of Step 48 to Step 72 correspond to the operation of the determining section, and each Step except Step 59 and Step 60 in the flow of Step 48 to Step 72 also corresponds to the operation of the determining section.

In the explanation below for Step 48 to Step 72, an example will be explained below in which a source text which is divided into 15 words (a number of divided words is a=15) based on the aforementioned longest match principle is specified as a search object, and parallel translated text candidates are extracted by using an array of parallel translated words (o, p, q, r, s, t, u, v, w, x, y, z, a, b, c) consisting of the 15 parallel translated words that correspond to the 15 words of the source text. The parallel translated words o, p, q, r, s, t, u, v, w, x, y, z, a, b, and c in the array represent the entire parallel translation words that each of them having nₒ, nₚ, n_{q}, nᵣ, nₛ, nₜ, nᵤ, nᵥ, n_{w}, nₓ, n_{y}, n_{z}, nₐ, n_{b}, and n_{c} number of the parallel translated words, respectively.

At Step 48, a value obtained by subtracting 1 from the number of divided words a (in this case the value is 14) is assigned to a variable i so that the variable i is initialized. The variable i represents a length of an array of words for which a web search is performed as described below. At the next Step 50, it is determined if the value of the variable i is 1 or not. When the determination is negative, at Step 52 a value 1 is assigned to a variable j. The variable j represents the head position of an array of words for which a web search is performed as described below.

At Step 54, it is determined if a value obtained by addition of the variable i to the variable j followed by subtraction of 1 is larger than the value a (the number of divided words) or not. Since the value a is 15 in this example, the determination at Step 54 is negative, and the processing moves to Step 58. At Step 58, it is determined if any of the j^{th} word to the (j+i−1)^{th} word in the number a words in the source text are not extracted by a web search, which will be explained below. At this time because the web search is not performed yet, the determination is positive, and the processing moves to Step 59. At the next Step 59, combination patterns of parallel translated words (parallel translation combination patterns) which correspond to the j^{th} word to the (j+i−1)^{th} word in the source text are generated. Step 59 corresponds to the operation of the generating section, and to the step of operating the generating sections to generate a plurality of subarrays of parallel translated words by the determining section. The parallel translation combination patterns generated at Step 59 correspond to the plurality of subarrays of parallel translated words which have smaller length than the plurality of arrays of parallel translated words, the plurality of subarrays correspond to combinations of the parallel translated words of a predetermined number of words in series in the source text in the source language, and also correspond to the “subarray of words” since the parallel translation combination patterns generated at Step 59 are a part of parallel translation combination patterns generated at Step 40.

At the next Step 60, a web search is sequentially performed for the individual parallel translation combination pattern generated at Step 59, in order to search for a text, which includes the parallel translation combination pattern (i.e., a text in which the individual parallel translated words of the parallel translation combination pattern of a search object appear in series in the same order as that in the parallel translation combination pattern), from all of the texts accessible via Internet 14 by using a search service which is provided by the web search services providing server. At this point under the condition of variable j=1 and (j+i−1)=14, parallel translation combination patterns which correspond to the array of parallel translated words from o to b deliminated by “|”, as described below, are generated at Step 59 (the number of the generated parallel translation combination patterns=nₒ×nₚ× . . . ×n_{b}), and a web search is sequentially performed at Step 60, in order to search for a text which includes each of the generated individual parallel translation combination pattern.

|o p q r s t u v w x y z a b|c

At the next Step 62, it is determined if any parallel translation combination pattern for which a relevant text is extracted by the web search performed at Step 60 (that is, the number of hit text is 1 or more) is found or not. When a negative determination is made, at Step 64 the variable j is incremented by 1, and the processing returns to Step 54. At this time under the condition of variable j=2 and (j+i−1)=15, the determination at Step 54 is negative and the determination at Step 58 is positive and the processing moves to Step 59. At Step 59, parallel translation combination patterns, as shown below, which correspond to the array of parallel translated words from p to c, where a position is displaced backward by one word relative to the previous array of words and has the same number of words as those of the previously generated array, are generated (the number of the generated parallel translation combination patterns=nₚ×n_{q}× . . . ×n_{c}), and a web search is sequentially performed at Step 60 in order to search for a text which includes any one of the generated parallel translation combination patterns.

o|p q r s t u v w x y z a b c|

If still no parallel translation combination pattern for which a relevant text is extracted by this web search is found and a negative determination is made at Step 62, at Step 64 the variable j is incremented by 1 again, and the processing returns to Step 54. At this time under the condition of variable j=3 and (j+i−1)=16, after a positive determination is made at Step 54, the variable i is decremented by 1 (i=13) at Step 56, and the processing returns to Step 50. After the determination at Step 50, at Step 52 the variable j is reset to 1. At this time under the condition of variable j=1 and (j+i−1)=13, after determinations at Step 54 and Step 58, at Step 59 parallel translation combination patterns, as shown below, which correspond to the array of parallel translated words from o to a are generated (the number of the generated parallel translation combination patterns=nₒ×nₚ× . . . ×nₐ), and a web search is sequentially performed at Step 60, in order to search for a text which includes any one of the generated individual parallel translation combination patterns.

|o p q r s t u v w x y z a|b c

If still no parallel translation combination pattern for which a relevant text is extracted by the web search is found and a negative determination is made at Step 62, at Step 64 the variable j is incremented by 1 again, and the processing returns to Step 54. At this time under the condition of variable j=2 and (j+i−1)=14, after determinations at Step 54 and Step 58, at Step 59, as shown below, parallel translation combination patterns which correspond to the array of parallel translated words from p to b, where a position is displaced backward by one word relative to the previous array of words and has the same number of words as those of the previously generated array, are generated (the number of generated parallel translation combination patterns=nₚ×n_{q}× . . . ×n_{b}), and a web search is sequentially performed at Step 60, in order to search for a text which includes any one of the generated parallel translation combination patterns.

o|p q r s t u v w x y z a b|c

If still no parallel translation combination pattern for which a relevant text is extracted by the web search is found and a negative determination is made at Step 62, at Step 64 the variable j is incremented by 1 again, and the processing returns to Step 54. At this time under the condition of variable j=3 and (j+i−1)=15, after determinations at Step 54 and Step 58, at Step 59, as shown below, parallel translation combination patterns, which correspond to the array of parallel translated words from q to c, where a position displaced backward by one word relative to the previous array of words and has the same number of words as those of the previously generated array, are generated (the number of generated parallel translation combination patterns=n_{q}×nᵣ× . . . ×n_{c}), and a web search is sequentially performed at Step 60, in order to search for a text which includes any one of the generated parallel translation combination patterns.

o p|q r s t u v w x y z a b c|

If still no parallel translation combination pattern for which a relevant text is extracted by the web search is found and a negative determination is made at Step 62, at Step 64 the variable j is incremented by 1 again, and the processing returns to Step 54. At this time under the condition of variable j=4 and (j+i−1)=16, after a positive determination is made at Step 54, at Step 56 the variable j is decremented by 1 (i=12), and the processing returns to Step 50. After the determination at Step 50, at Step 52 the variable j is reset to 1. At this time under the condition of variable j=1 and (j+i−1)=12, after determinations at Step 54 and Step 58, at Step 59 parallel translation combination patterns which correspond to the array of parallel translated words from o to z are generated (the number of generated parallel translation combination patterns=nₒ×nₚ× . . . ×n_{z}) as shown below, and a web search is sequentially performed at Step 60, in order to search for a text which includes one of the generated parallel translation combination patterns.

|o p q r s t u v w x y z|a b c

Similarly, while no parallel translation combination pattern for which a relevant text is extracted by a web search is found, a generation of parallel translation combination patterns for an array of words where the position of the head word of the array of words in the source text (which is used for the generation) is displaced backward by one word relative to the previous array of words in the source text and a web search for each generated pattern will be repeated. Every time the tail end of an array of words in the source text which is used for the generation of parallel translation combination patterns comes to the tail end of the source text (every time a positive determination is made at Step 54), the length of an array of words in the source text which is used for the generation of parallel translation combination patterns is reduced by one word.

Now, subsequent processings will be explained below by way of an example in which, under a condition that the variable i (i.e., the number of words in the array of words in the source text which is used for the generation of parallel translation combination patterns)=4, the variable j (i.e., the position of the head word in the array of words in the source text which is used for the generation of parallel translation combination patterns)=4, and (j+i−1)=7, after determinations at Step 54 and Step 58, at Step 59 parallel translation combination patterns which correspond to the array of parallel translated words from r to u are generated (the number of generated parallel translation combination patterns=nᵣ×nₛ×nₜ×nᵤ) as shown below, and a web search is sequentially performed at Step 60, in order to search for a text which includes any one of the generated parallel translation combination patterns, resulting in finding of a parallel translation combination pattern for which a relevant text is extracted.

o p q|r s t u|v w x y z a b c

In this case, after a positive determination is made at Step 62, at Step 66 the number of the parallel translation combination patterns for which a relevant text is extracted by the web search is recognized. When the recognized number is 1, the only one parallel translation combination pattern for which a relevant text is extracted by the web search is stored in the HDD 16C (the storing section) as a parallel translation candidate for an array of j^{th} to (j+i−1)^{th} words among the array of words in the source text. When there is plural parallel translation combination patterns for which a relevant text is extracted by the web search at Step 60, the parallel translation combination pattern which has the largest number of hit texts among the parallel translation combination patterns is determined, and on the basis of the parallel translation combination pattern with the largest number of hit texts (taken as 100%), proportions of the numbers of hit texts for other parallel translation combination patterns are computed. Then the parallel translation combination patterns which have proportions of the number of hits equal to or larger than a threshold value are stored in the HDD 16C as parallel translation candidates for the array of j^{th} to (j+i−1)^{th} words among the array of words in the source text.

At the next Step 68, the variable j is incremented by 1, and the processing returns to Step 54. At this time under the condition of variable j=5 and (j+i−1)=8, although a negative determination is made at Step 54, the parallel translated words corresponding to the 4^{th} to 7^{th} words in the source text already have the hit texts by the web search (the parallel translated words which have hit texts are shown below in capitalized letters between the brackets “[” and “]”).

o p q [R S T U] v w x y z a b c

Therefore, a negative determination is made also at Step 58 and the variable j is incremented by 1 at Step 64, and the processing returns to Step 54. Thus, the determination at Step 58 corresponds to the step to “exclude a predetermined number of words in the source text which corresponds to the subarray of parallel translated words stored in the storing section from words to be used for a subsequent generation of subarrays of parallel translated words”. This loop of Steps 54, 58, and 64 will be repeated until a positive determination is made at Step 58, under a condition of variable j=8 and (j+i−1)=11, and no parallel translated words corresponding to the j^{th} to (j+i−1)^{th} words in the source text which have hit texts by a web search are found. Thereafter, under the condition of variable j=8 and (j+i−1)=11, a positive determination is made at Step 58, at Step 59 parallel translation combination patterns which correspond to the array of parallel translated words from v to y are generated (the number of generated parallel translation combination patterns=nᵥ×n_{w}×nₓ×n_{y}) as shown below, and a web search is sequentially performed at Step 60, in order to search for a text which includes any one of the generated individual parallel translation combination patterns.

o p q [R S T U] |v w x y|z a b c

If no parallel translation combination pattern for which a relevant text is extracted by the web search is found and a negative determination is made at Step 62, at Step 64 the variable j is incremented by 1 again, and the processing returns to Step 54. At this time under the condition of variable j=9 and (j+i−1)=12, after determinations at Step 54 and Step 58, as shown below, at Step 59 parallel translation combination patterns, which correspond to the array of parallel translated words from w to z, where a position displaced backward by one word relative to the previous array of words and has the same number of words as those of the previously generated array, are generated (the number of generated parallel translation combination patterns=n_{w}×nₓ×n_{y}×n_{z}), and a web search is sequentially performed at Step 60, in order to search for a text which includes any one of the generated parallel translation combination patterns.

o p q [R S T U] v|w x y z|a b c

In a case where any parallel translation combination pattern for which a relevant text is extracted by the web search is found, after a positive determination is made at Step 62, the processing moves to Step 66. At Step 66, when the number of the parallel translation combination pattern for which a relevant text is extracted by the web search is 1, the only one parallel translation combination pattern for which a relevant text is extracted by the web search is stored in the HDD 16C as a parallel translation candidate for the array of j^{th} to (j+i−1)^{th} words among the array of words in the source text. When there is a plurality of parallel translation combination patterns for which a relevant texts is extracted by the web search, the proportions of the numbers of hit texts for the parallel translation combination patterns are computed with respect to the number of hit texts for the parallel translation combination pattern having the largest number of hit texts (taken as 100%) among the parallel translation combination patterns. And the parallel translation combination patterns which have proportions of the number of hits equal to or larger than a threshold value are stored in the HDD 16C as parallel translation candidates for the array of j^{th} to (j+i−1)^{th} words among the array of words in the source text. Then the variable j is incremented by 1, and the processing returns to Step 54.

At this time under the condition of variable j=10 and (j+i−1)=13, although a negative determination is made at Step 54, the parallel translated words corresponding to the 4^{th} to 7^{th} and 8^{th} to 11^{th} words in the source text already have the hit texts extracted by web search (see the arrays of the parallel translated words below).

o p q [R S T U] v [W X Y Z] a b c

Therefore, a negative determination is made at Step 58, and the processing enters into the above-described loop of Steps 54, 58, and 64.

At this time, since there are only 3 (<i) words in series after the 11^{th} word in the source text which the corresponding parallel translated words are not hit by web search, under the condition of variable j=13 and (j+i−1)=16, a positive determination is made at Step 54, thereby searches for the parallel translation combination patterns with the variable (the number of parallel translated words) i=4 are completed. Then at Step 56 the variable i is decremented by 1 (i=3), and the variable j is reset to 1 at Step 52 after the determination at Step 50.

Then next, searches for parallel translation combination patterns with the variable (the number of parallel translated words) i=3 will be performed. Because only the 1^{st} to 3^{rd} and 13^{th} to 15^{th} words in the source text are the arrays containing three or more words in series, and which the corresponding parallel translated words are not hit by web search, the generation of parallel translation combination patterns (Step 59) and the web search for texts which include any one of generated parallel translation combination pattern (Step 60) are sequentially performed only for the array of the parallel translated words from o to q and the array of the parallel translated words from a to c.

|o p q| [R S T U] v [W X Y Z] a b c

o p q [R S T U] v [W X Y Z] |a b c|

In a case where any parallel translation combination pattern for which a relevant text is extracted by the web search for the parallel translation combination pattern corresponding to the parallel translated words from a to c is found, at Step 66, when the number of the parallel translation combination pattern for which a relevant text is extracted by the web search is 1, the only one parallel translation combination pattern for which a relevant text is extracted by the web search is stored in the HDD 16C as a parallel translation candidate for the array of j^{th} to (j+i−1)^{th} words, that is the 13^{th} to 15^{th} words, among the array of words in the source text. When there are plural parallel translation combination patterns for which a relevant text is extracted, the proportions of the numbers of hit texts for the parallel translation combination patterns with respect to the number of hit texts for the parallel translation combination pattern having the largest number of hit texts among the parallel translation combination patterns (taken as 100%) are computed. And the parallel translation combination patterns in which proportions of the number of hit texts are equal to or larger than a threshold value are stored in the HDD 16C as parallel translation candidates for an array of 13^{th} to 15^{th} words in the source text. The array of parallel translated words, when all searches for parallel translation combination patterns with the variable (the number of parallel translated words) i=3 are completed, is shown below.

o p q [R S T U] v [W X Y Z] [A B C]

Next, searches for parallel translation combination patterns with the variable (the number of parallel translated words) i=2 will be performed. Because only the 1^{st} to 3^{rd} words in the source text is the array containing two or more words in series which the corresponding parallel translated words are not hit by web search, the generation of parallel translation combination patterns (Step 59) and the web search for texts which includes any one of the generated parallel translation combination pattern (Step 60) is sequentially performed only for the array of the parallel translated words from o to q and the array of the parallel translated words from p to q as shown below.

|o p|q [R S T U] v [W X Y Z] [A B C]

o|p q| [R S T U] v [W X Y Z] [A B C]

In a case where any parallel translation combination pattern for which a relevant text is extracted by the web search for the parallel translation combination pattern corresponding to the parallel translated words p and q is found, at Step 66, when the number of the parallel translation combination patterns for which a relevant text is extracted by the web search is 1, the only one parallel translation combination pattern for which a relevant text is extracted by the web search is stored in the HDD 16C as a parallel translation candidate for an array of j^{th} to (j+i−1)^{th} words, that is the 2^{nd} to 3^{rd} words, among the array of words in the source text. When there is plural parallel translation combination patterns for which relevant texts are extracted, the proportions of the numbers of hit texts for the parallel translation combination patterns with respect to of the number of hit texts for the parallel translation combination pattern having the largest number of hit texts (taken as 100%) among the parallel translation combination patterns are computed. And the parallel translation combination patterns which the proportions of the numbers of hit texts are equal to or larger than a threshold value are stored in the HDD 16C as parallel translation candidates for the array of 2^{nd} to 3^{rd} words in the source text. The array of parallel translated words, when the all searches for parallel translation combination patterns with the variable (the number of parallel translated words) i=2 are completed, is shown below.

o [P Q] [R S T U] v [W X Y Z] [A B C]

When all searches for parallel translation combination patterns with the variable (the number of parallel translated words) i=2 are completed, a positive determination is made at Step 54, and the variable i is incremented by 1 (i=1) at Step 56, so that a positive determination is made at Step 50, thereby the processing moves to Step 70. At the time the processing moves to Step 70, the array of words in the source text to be translated have already been divided into several divided patterns (in the above example, the arrays of words of [PQ], [RSTU], [WXYZ], and [ABC], in which the parallel translation combination patterns thereof that have proportions of the numbers of hits equal to or larger than the threshold value are stored in the HDD 16C as parallel translation candidates, and the other words o and v) which are considered to provide more probable parallel translated texts.

At Step 70, among each of constituent (an array of words or a word) of the source text which is divided into the divided patterns, for the arrays of words having the stored parallel translation candidates (parallel translation combination patterns) each of which has a proportion of the numbers of hits equal to or larger than the threshold value, all of the parallel translation candidates are read out from the HDD 16C, while for the words having corresponding parallel translated words for which no text is extracted by web search, all of the parallel translated words obtained from the bilingual lexicon DB are read out from the HDD 16C. Then, combinations (parallel translated text candidates) of the read out parallel translation candidates and parallel translated words are generated. Thus, when the divided patterns have a number b of constituents and each constituent has a number n₁, n₂, . . . , n_{b} of parallel translation candidates or parallel translated words, a number n₁×n₂× . . . ×n_{b} of parallel translated text candidates are generated.

Then, a web search is sequentially performed for all of the parallel translated text candidates generated in the above described processing in order to search for a text which includes all of the parallel translated words in the generated parallel translated text candidate (a text which includes every parallel translated word in a certain parallel translated text candidate, regardless of whether the word order is the same as or different from that in the certain parallel translated text candidate, and whether the words are serially used or separately used), from all of the texts accessible via the Internet 14, by using a search service which is provided by the web search services providing server. This examines the co-occurrence probability of the parallel translated words in each parallel translated text candidate.

At the next Step 72, when one parallel translated text candidate for which a relevant text is extracted by the web search at Step 70 is found, the only one parallel translated text candidate for which a text is extracted by the web search is output as a parallel translated text candidate which corresponds to the source text, and the processing for parallel translation determination is completed. When there is plural parallel translated text candidates for which a relevant text is extracted by the web search at Step 70, with respect to the number of hit texts for the parallel translated text candidate having the largest number of hit texts among the parallel translated text candidates (taken as 100%), the proportions of the numbers of hit texts for the other parallel translated text candidates are computed. Then the parallel translated text candidates which have proportions of the numbers of hit texts equal to or larger than a threshold value are output as parallel translated text candidates for the source text, and the processing for parallel translation determination is completed. Also in this case, among the plural parallel translated text candidates which include the parallel translation candidates stored in the HDD 16C at Step 66 based on the web search results, the parallel translated text candidate which is considered to have the highest or higher naturalness as a sentence in the target language based on the co-occurrence probability will be output as a parallel translated text candidate which corresponds to the source text.

In the above described embodiment, plural parallel translation combination patterns which corresponds to each combination of parallel translated words for a predetermined number of words in series in a source text among the words in the source text are generated, and for each generated parallel translation combination pattern, sequential search of a text which includes the generated parallel translation combination pattern are repeatedly performed with the number of words in the source text to be used for the generation of parallel translation combination patterns being reduced one by one, parallel translation combination pattern(s) for which a relevant text is extracted by the search is adopted (stored) as a parallel translation candidate, and the array of words in the source text which corresponds to the adopted parallel translation combination pattern is excluded from the words to be used for the subsequent generation of parallel translation combination patterns. Thus a parallel translated text candidate is determined primarily based on the length (the number of words) of the parallel translation combination pattern for which a relevant text is extracted by the search instead of the number of the relevant texts which are extracted by the search. However, the present invention is not limited to the above embodiment. In order to eliminate the possibility that a certain long parallel translation combination pattern would be adopted as a part of a parallel translated text candidate because a text which includes the parallel translation combination pattern happens to be found from accessible texts via the Internet, although the certain parallel translation combination pattern has a lower degree of naturalness in a target language, for example, in a search for parallel translation combination patterns, only when the number of relevant hit texts is equal to or larger than a reference value, the corresponding parallel translation combination pattern may be adopted as a parallel translation candidate. Alternately, the array of words in the source text which corresponds to the parallel translation combination pattern having an extracted relevant text may not be excluded from the words to be used for the subsequent generation of parallel translation combination patterns. After the generation of parallel translation combination patterns and the web search for the generated parallel translation combination patterns are performed, for all of the parallel translation combination patterns for which relevant texts are extracted by the web search, the lengths of the parallel translation combination patterns and the number of hit texts for the parallel translation combination patterns may be compared to select a parallel translation combination pattern to be adopted as a parallel translation candidate and a parallel translation text candidate may be generated.

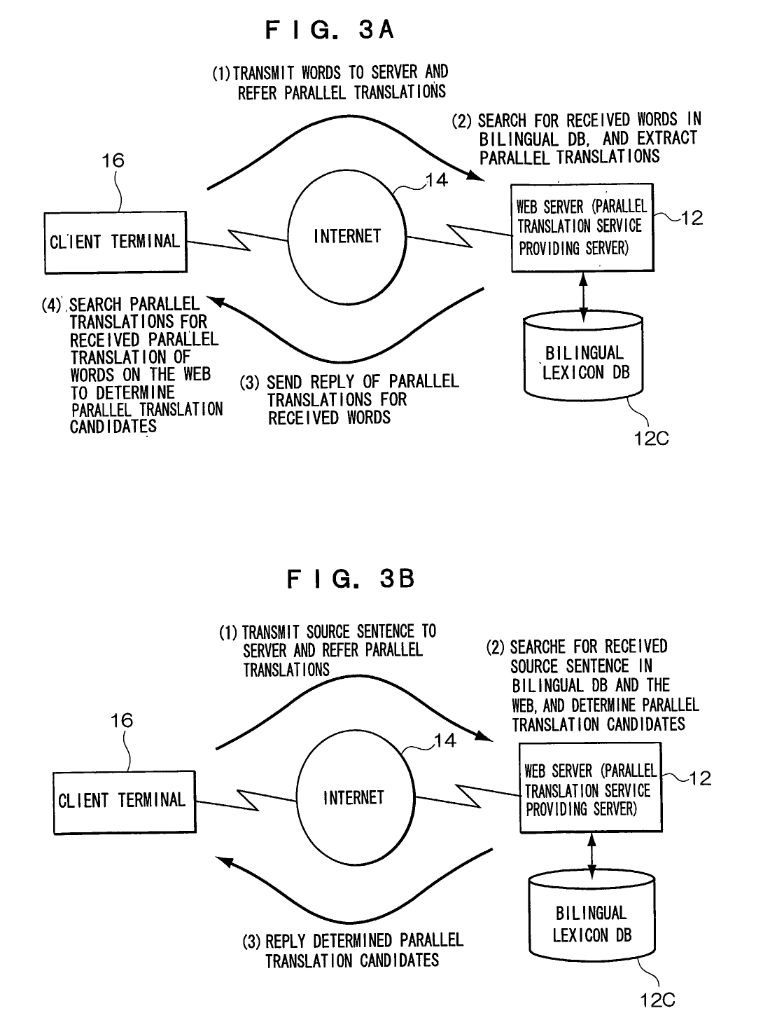

In the above described aspect, the bilingual lexicon DB is stored in the HDD 16C of the client terminal 16, but the present invention is not limited to this embodiment. For example, as shown in FIG. 3A, other configurations may be used in which the bilingual lexicon DB is stored in the HDD 12C of the web server 12 which is connected to the Internet 14 and functions as a bilingual (multilingual/parallel translation) service providing server. For determining a parallel translation for a specified source text to be translated, the client terminal 16 may obtain parallel translations for each word in the source text by referring to the bilingual service providing server (see (1) to (3) of FIG. 3A), and then may perform web searches based on the obtained parallel translations for each word to determine a parallel translated text for the source text (a parallel translated text candidate which corresponds to the source text).

In the above described embodiment, the determination on a parallel translation for the source text (a parallel translated text candidate which corresponds to the source text) is made at the client terminal 16, but the present invention is not limited to this embodiment. For example, as shown in FIG. 3B, other configurations may be used in which the bilingual lexicon DB is stored in the HDD 12C of the web server 12 which functions as the bilingual service providing server, and also a program for executing processing similar to the above-described processing for parallel translation determination is installed in the HDD 12C in advance. Upon reference to a parallel translated text for the source text by receiving text data of the source text from the client terminal 16 (see (1) of FIG. 3B), the web server 12 may obtain parallel translations for each word in the received source text from the bilingual lexicon DB, perform web searches based on the obtained parallel translations for each word, determine a parallel translated text for the source text (a parallel translated text candidate which corresponds to the source text) (see (2) of FIG. 3B), and send the determined parallel translated text to the client terminal 16 which made the reference (see (3) of FIG. 3B). In the above described aspect, the web server 12 which functions as the bilingual service providing server corresponds to the computer, and the program which is installed in the web server 12 in advance corresponds to the program for determining the naturalness of an array of words according.

Furthermore, in the above description, the present invention is applied to an embodiment for determining a parallel translated text which corresponds to the source text specified as a translation object; but the present invention is not limited to the determination of the parallel translated text. For example, the present invention may be applied to an embodiment that, when there is plural arrays of words each of which are composed as a sentence, automatically determining and evaluating an array of words which has higher naturalness as a sentence.

1. An apparatus for determining the naturalness of an array of words which is realized in a computer connected to the Internet, the apparatus comprising:
a searching section, for searching for an array of words specified as a search object in texts accessible via Internet; and
a determining section for causing the searching section to perform the search by specifying, as a search object, an array of words of a determination object in which a plurality of words are arrayed, and determining the naturalness of the array of words as a sentence, based on the presence or absence of a text extracted by the search and the number of the extracted texts,
wherein the determining section specifies the entire array of words of the determination object as a search object and causes the searching section to perform a search for the array, and when no relevant text is extracted by the search, the determining section repeatedly performs processing of extracting, from the array of words of the determination object, a subarray of words, as a search object, which has a smaller length than the entire array of words of the determination object, and causing the searching section to perform a search by specifying the subarray of words as a search object, with the length of the subarray of words to be extracted as a search object being reduced gradually, and determines the naturalness of the array of words as a sentence based on the presence or absence of a text extracted by the search, the number of texts extracted by the search, and the length of the subarray of words as the search object for which the text is extracted.

2. (canceled)

3. The apparatus for determining the naturalness of an array of words according to claim 1, further comprising: a generating section for obtaining a parallel translated word in a target language for each word of a source text in a source language and generating, as the array of words of the determination object, a plurality of arrays of parallel translated words in the target language, which correspond to combinations of the parallel translated words obtained for each word of the source text,
wherein the determining section specifies, as a search object, each of the plurality of arrays of parallel translated words generated by the generating section, and causes the searching section to perform a search for each of the arrays, and the determining section selects an array of parallel translated words which has higher naturalness as a sentence in the target language from among the plurality of arrays of parallel translated words based on the presence or absence of a text extracted by each search and the number of the extracted texts.

4. The apparatus for determining the naturalness of an array of words according to claim 3, wherein the determining section specifies, as a search object, the entirety of the array in the plurality of arrays of parallel translated words and causes the searching section to perform a search for each of the arrays, and when no relevant text is extracted by the search, the determining section repeatedly performs processing of causing the generating section to generate a plurality of subarrays of parallel translated words each of which has smaller length than the entirety of the array in the plurality of arrays of parallel translated words, the plurality of subarrays being combinations of the parallel translated words corresponding to a predetermined number of words in series in the source text in the source language, and the determining section specifying each of the generated subarrays of the plurality of parallel translated words as a search object and causing the searching section to perform a search for each of the subarrays, with the number of the words in the source text to be used for the generation of the subarrays of parallel translated words being reduced gradually, and the determining section selecting an array of parallel translated words which has higher naturalness as a sentence in a target language from among the arrays of the plurality of parallel translated words based on the presence or absence of a text extracted by the search, the number of the extracted texts, and the number of words in the subarray of parallel translated words as the search object for which the text is extracted.

5. The apparatus for determining the naturalness of an array of words according to claim 4, further comprising a storing section,
wherein every time a relevant text is extracted by the search, the determining section stores the subarray of parallel translated words used for the search in the storing section, and excludes the predetermined number of words in the source text which correspond to the stored subarray of parallel translated words from words to be used for a subsequent generation of a subarray of parallel translated words, and when no more words in series exists in the source text which can be used for a subsequent generation of a subarray of parallel translated words, for each of the stored combinations of the subarrays of parallel translated words, the determining section causes the searching section to perform a search for a text which includes all of the parallel translated words in the combination, and the determining section selects a combination of the subarrays of parallel translated words which has higher naturalness as a sentence in the target language from among the stored combinations of subarrays of parallel translated words which, based on the presence or absence of a text which includes all of the parallel translated words in the combination and the number of the texts which includes all of the parallel translated words and are extracted by the search.

6. A method for determining the naturalness of an array of words which is realized in a computer connected to Internet, the method comprising:
searching for an array of words of a determination object, in which a plurality of words is arrayed, in texts accessible via the Internet; and
determining the naturalness of the array of words of the determination object as a sentence based on the presence or absence of a text extracted by the search and the number of the extracted texts,
wherein the determining comprises:
specifying the entire array of words of the determination object as a search object;
searching for the array;
repeatedly extracting, when no relevant text is extracted by the search, from the array of words of the determination object, a subarray of words, as a search object, which has a smaller length than the entire array of words of the determination object;
performing a search by specifying the subarray of words as a search object, with the length of the subarray of words to be extracted as a search object being reduced gradually; and
determining the naturalness of the array of words as a sentence based on the presence or absence of a text extracted by the search, the number of texts extracted by the search, and the length of the subarray of words as the search object for which the text is extracted.

7. A storage medium storing a program for determining the naturalness of an array of words, which allows a computer connected to the Internet to function as an apparatus for determining the naturalness of an array of words, the program causes the computer to perform processings comprising:
searching for an array of words, which is specified as a search object, in texts accessible via Internet, the search is performed by specifying as the search object an array of words of a determination object in which a plurality of words is arrayed; and
determining the naturalness of the specified array of words of the determination object as a sentence based on the presence or absence of a text extracted by the search, and the number of the extracted texts,
wherein the determining comprises:
specifying the entire array of words of the determination object as a search object;
searching for the array;
repeatedly extracting, when no relevant text is extracted by the search, from the array of words of the determination object, a subarray of words, as a search object, which has a smaller length than the entire array of words of the determination object;
performing a search by specifying the subarray of words as a search object, with the length of the subarray of words to be extracted as a search object being reduced gradually; and
determining the naturalness of the array of words as a sentence based on the presence or absence of a text extracted by the search, the number of texts extracted by the search, and the length of the subarray of words as the search object for which the text is extracted.
